(19) United States
(12) Patent Application Publication
(10) Pub. No.: US 2003/0081740 A1
(43) Pub. Date: May 1, 2003

(54) Remote callerID information retrieval system and method

(75) Inventor: Daniel J. Piotrowski, Edison, NJ (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 10/144,815

(22) Filed: Oct. 25, 2001

(51) Int. Cl. H04M 11/00

(52) U.S. Cl. 379/88.18

(57) ABSTRACT

Methods and apparatus for providing a messaging arrangement allowing a user to remotely receive or download callerID information regarding a call made to the user's telephone/messaging system (MS), regardless whether the caller stored a message in a recipient's MS. The MS stores the caller's callerID information in a recipient's storage medium. Thereafter, the user or other authorized person, who has reached the user's MS, is provided access to the particular stored callerID information. The user can retrieve the callerID information, for example using a remote terminal, such as a wireless phone, or download the information to a PDA or a computer/Internet appliance via the Internet.

### FIELD OF THE INVENTION

This invention relates to telecommunications messaging/telephone systems, such as electronic messaging arrangements, and more particularly, to systems and methods to enable a user to remotely receive or download callerID information, e.g. CallerID information, regarding a call made to the user's telephone or messaging system (MS) in which the caller may not have stored a message in a recipient's MS.

### BACKGROUND OF THE INVENTION

The capability of generating and delivering voice messages under program control to users is well known in the art. Examples thereof are voice-mail systems and interactive voice recognition (e.g., programmed conversation) systems. These systems are designed to provide the capability of delivering voice messages under program control to a user's voice mailbox. Such a message system is disclosed in U.S. Pat. No. 5,311,576, incorporated herein by reference.

However such conventional electronic messaging systems are intended to simply store a caller's message. These stored messages can then be retrieved locally or remotely through a dial-in procedure. In addition, CallerID information is available to users, which can be stored in the user telephone or attached device. Such callerID information and devices are disclosed in British Patent No. GB 2,258,119 B, (Type-2 CID is an extension of and includes all of the functionality of the type-I CID, which is disclosed in U.S. Pat. No. 4,582,956 and incorporated herein by reference). With callerID, the telephone company transmits encoded information to the user's telephone between the first and second ring signals. This encoded information (caller ID information) typically includes the name and telephone number of the calling party. The user may purchase or lease customer premises equipment (e.g. a telephone) which connects to the user's telephone line and detects, decodes and displays the encoded information. Although, a recipient can receive such callerID information locally, e.g. via the user's phone or attached device, known telephones or attached devices do not offer the recipient the capability to receive such information remotely or download such information to a mobile terminal, such as a personal digital assistant (PDA) or wireless phone.

Once a caller decides not to record a message to the user's MS, the user has no way of determining who called until they can review the callerID information locally, using the called telephone or attached device. Users may wish to have this information for a variety of reasons, such as determining prank callers, the determination level of callers (e.g. number of call from a particular caller), or simply the knowledge of who is calling them. Moreover, many people simply refuse to record important or confidential messages on a person's VMS. Furthermore, many times it is less important for the originator to actually receive a message, than to have knowledge that a caller has called, and when. For example, a person may be waiting for a call from a particular caller who she interested in romantically. In these situations, the user is forced to repeat the message retrieval process to no avail.

### SUMMARY OF THE INVENTION

Certain problems relating to telephone/messaging systems are reduced or overcome by a method and system in accordance with the principles of the present invention. While the actual nature of the present invention covered herein can only be determined with reference to the claims appended hereto, certain features, which are characteristic of the embodiments disclosed herein, are described briefly as follows. The apparatus and method enable a user to remotely receive or download callerID information regarding a call made to the user's telephone/messaging system (MS), (hereinafter “MS”), regardless whether the caller stored a message in a recipient's MS. In an illustrative embodiment the MS stores the caller's message and/or callerID information in a recipient's storage medium. Thereafter, the user can retrieve the messages/callerID information, for example using a remote terminal, such as a wireless phone, or download the information to a PDA or a computer/Internet appliance via the Internet. Thus, the recipient or user gains the ability to review the callerID information remotely. In turn, the recipient may take the appropriate action, such as return the originator's call, using the retrieved callerID information.

According to another aspect of the invention, the user can provided an alert when a particular caller's callerID information is stored in the system to the user's mobile terminal, e.g. PDA or wireless phone. In addition, the user may selectively determine the form of the transmission, such as email, pager, text to speech, etc. in which they are notified of the stored callerID information.

### BRIEF DESCRIPTION OF THE DRAWING

These and other advantages and features of the invention will become more apparent from the following description of an illustrative embodiment of the invention considered together with the drawings, in which:

FIG. 1 is a block diagram of a MS according to one embodiment of the invention; and

FIG. 2 is a flow diagram of the functions performed in response to a recipient accessing the MS of the system of FIG. 1.

### DETAILED DESCRIPTION

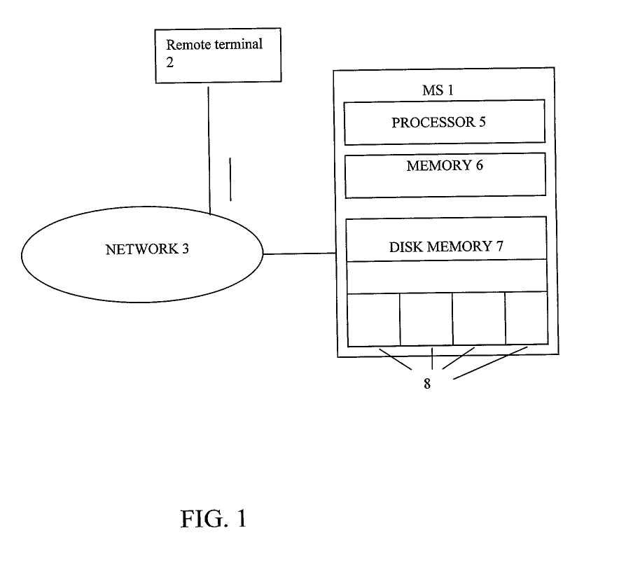

In accordance with the invention, an MS as shown in FIG. 1 enables a user to remotely receive or download callerID information regarding a call made to the user's MS, regardless whether the caller stored a message in a recipient's MS. A message originator or caller shall be defined herein to mean those persons, groups or other entities that call a recipient's message storage device. A recipient shall mean herein for example, any subscriber or user of the MS. MS 1 includes, for example, one or more conventionally available voice message systems. MS 1 also configured for use in a Caller ID system, which includes conventional elements (not shown) such as a ring detect circuit, telephone line interface circuit, off-hook detect circuit, line termination and voice transmission path circuit, frequency shift keying detector circuit, microcontroller, LCD display, and a voice generation circuit. The voice generation circuit may include a voice synthesizer circuit, record and playback circuit, speaker, microphone, record key and playback keys. Remote terminal 2 is used to interconnect with one or more MSs via network 3, such a local telephone switching network, or a private branch exchange (PBX), wireless network or the Internet. Network 3 may be interconnected to other networks that may interconnect other MSs and remote terminals.

The MS 1 of FIG. 1 is a processor-controlled unit operating under stored-program control. MS 1 includes a processor 5 which executes programs stored in a memory 6, and a disk memory 7 that includes a plurality of subscriber mailboxes 8. In addition to conventional functions, such as storing a recipients messages in mailboxes 8, MS 1 stores callerID information (e.g. caller ID information, as described above) in mailboxes 8. As will be understood by those skilled in the art, the mailboxes 8 can be any conventional database/indexing storage system that can store and allow access to message/data related to a particular user.

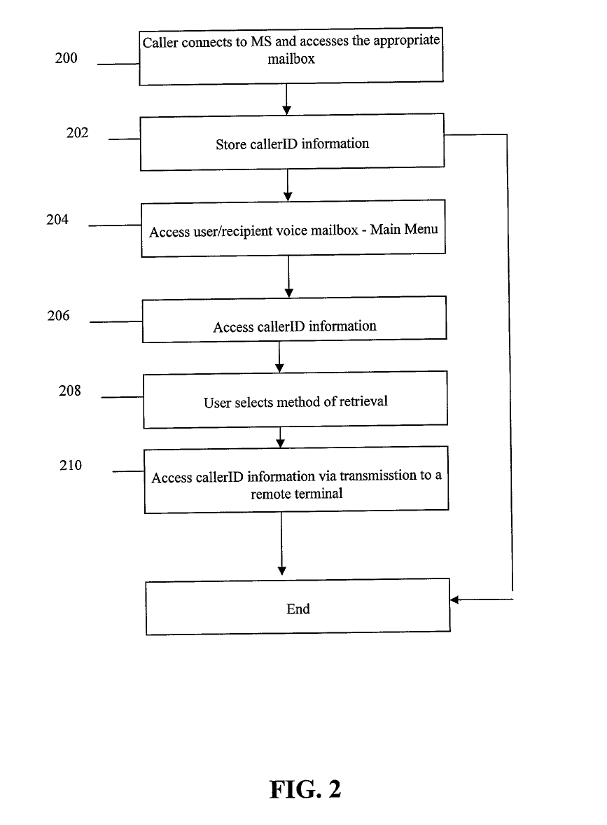

Further, MS 1 includes in memory 6 programs that are functionally described in FIG. 2. Execution of these programs implements the steps to enable the MS to store callerID information as well as allow a user to remotely retrieve or download the callerID information.

As shown in FIG. 2, a user connects to MS 1 via 14 network 3 of FIG. 1. In particular, the caller is connected to the user's mailbox 8 in MS 1 in step 200. A determination is made, by processor 5, as to the identity of the called user, so that the appropriate mailbox 8 can be accessed. Alternatively, if the MS is a telephone without a messaging system processor 5 does not need to determine a mailbox and simply stores the callerID in memory. Step 200 also typically announces a greeting to the caller, and guides the caller through various menu options. The caller may elect to record a message. However, regardless whether the caller records a message, callerID information is stored in the recipient's mailbox 8 in step 202. The callerID information will continue to be stored in the recipient's mailbox 8 until deleted by the user or for the duration of a programmed storage time.

Operationally, for each call made to the MS callerID information data is generated by processor 5, for example, a time and date stamp, and stored in mailbox 8, which may be reviewed by a user.

Thus, a user may remotely receive callerID information, as well as conventional stored messages at any time prior to the expiration of the storage time. Illustratively this is done by using the main menu, which is described above with regard to FIG. 2, containing various choices for further action in step 204 of FIG. 2. For example, the main menu at step 204 includes the conventional options for MS which may be used to prompt a caller for various actions, such as, press one, to record a voice mail message, press two, for an operator, if available, and the like.

In addition to these conventional option selections the system advantageously includes an option selection such as, for example, press three, for callerID information review. Selection of this option directs a user to the callerID information menu, step 206 in FIG. 2. Thereafter, in step 206, an announcement prompts the user, for example, to press one, to review all stored callerID information; press two, to return to the main menu; or press three, to delete callerID information. Thereafter in step 208, the user can select to method of retrieval of any stored callerID information (e.g., conventional—email, text messaging, pager, text to speech, etc.). In step 210, the user retrieves any callerID information callerID information, for example using a mobile terminal, such as a wireless phone or downloads the callerID information to a PDA or a computer via the Internet.

According to another aspect of the invention, the user is provided an alert when a particular caller's callerID information is stored in the system to the user's mobile terminal, e.g. PDA or wireless phone. For example, the user defines a list of callerID information, which the user provides MS 1 of FIG. 1 via conventional methods. MS 1 compares the callerID information of a received called, e.g., area code, phone number, name, etc. with the user's stored list. If the callerID information matches one on the user defined list it is recognized and an alert message is sent, via a similar manner as described above with callerID information retrieval, to the user.

The following merely illustrates the principles of the invention. It will thus be appreciated that those skilled in the art will be able to devise various arrangements which, although not explicitly described or shown herein, embody the principles of the invention and are included within its spirit and scope. Furthermore, all examples and conditional language recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams herein represent conceptual views of illustrative circuitry embodying the principles of the invention. Similarly, it will be appreciated that any flow charts, flow diagrams, state transition diagrams, and the like represent various processes which may be substantially represented in computer readable medium and so executed by a computer or processor, whether or not such computer or processor is explicitly shown.

The functions of the various elements shown in the FIG. 1, including functional blocks labeled as “processors” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read-only memory (ROM) for storing software, random access memory (RAM), and non-volatile storage. Other hardware, conventional and/or custom, may also be included. Their function may be carried out through the operation of program logic, through dedicated logic, through the interaction of program control and dedicated logic, or even manually, the particular technique being selectable by the implementor as more specifically understood from the context.

In the claims hereof any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicant thus regards any means which can provide those functionalities as equivalent as those shown herein.

What is claimed is:

1. A method of operating a messaging arrangement, comprising the steps of:
storing callerID information from a message originator in a storage means of a recipient; and
providing said recipient with remote access to callerID information.

2. The method of claim 1, further including the step of transmitting said callerID information to a remote terminal.

3. The method of claim 2, further including the step of allowing the recipient to select the method of transmission of said callerID information.

4. The method of claim 3, wherein the method of transmission is selected-from the group consisting email, text messaging, file transfer and speech messaging

5. The method of claim 1, further including the steps of, allowing a user to store a defined list of callerID information;
comparing said callerID information with said defined list;
sending an alert message to said remote terminal if said callerID information matches said defined list.

6. A messaging apparatus comprising:
means for storing callerID information of a caller in said messaging apparatus; and
means responsive to a user of said messaging apparatus for providing said user remote access to said callerID information.

7. The messaging apparatus of claim 6, further including means for transmitting said callerID information to a remote terminal.

8. The messaging apparatus of claim 7, further including means for allowing the recipient to select the method of transmission of said callerID information.

9. The messaging apparatus of claim 8, further including, means for allowing a user to store a defined list of callerID information;
means for comparing said callerID information with said defined list; and
means for sending an alert message to said remote terminal if said callerID information matches said defined list.

10. A messaging apparatus comprising:
a memory for storing callerID information from a caller;
a processor, responsive to a user of said messaging apparatus for providing said user remote access to said callerID information and transmitting said callerID information to a remote terminal.

11. The messaging apparatus of claim 10, wherein the remote terminal is selected from the group consisting of a wireless phone, computer, PDA, Internet appliance and pager.
